(19) United States
(12) Patent Application Publication
(10) Pub. No.: US 2026/0077640 A1
(43) Pub. Date: Mar. 19, 2026

(54) Outboard motor locking device with battery storage

(71) Applicant: Godu LLC, Abingdon, VA (US)

(72) Inventor: Kyle Michael Hawkins, Abingdon, VA (US)

(21) Appl. No.: 19/302,174

(22) Filed: Aug. 18, 2025

Related U.S. Application Data
(60) Provisional application No. 63/694,859, filed on Sep. 15, 2024.

(51) Int. Cl. B60K 1/04; B60L 3/04; B60L 50/60; B60L 50/64

(52) U.S. Cl. CPC B60K 1/04; B60L 3/04; B60L 50/64; B60L 50/66; B60K 2001/0416; B60L 2200/32

(57) ABSTRACT

An outboard motor locking device with integrated battery storage secures a portable outboard motor to a boat transom while providing protected battery mounting for electric start systems. A hinged lock bar having upper and lower members with cutouts surrounds the transom clamp screws of an outboard motor, preventing motor removal. A weather-resistant battery enclosure suspended from the lower member contains a marine battery with pre-installed wiring and external circuit breaker. When locked in position, the battery enclosure's access panel faces the transom, making the battery inaccessible without first removing the entire device. The integrated design provides theft deterrence for both motor and battery as a single unit. Electrical terminals extend from the enclosure for direct connection to the outboard motor. The device transforms complex marine electrical installation into simple attachment while meeting marine safety standards and keeping the battery elevated.

### CROSS-REFERENCE TO RELATED APPLICATION

This application is a continuation-in-part of U.S. Pat. App. Ser. No. 63/694,859 , filed Sep. 15, 2024.

### FIELD

This invention relates to the field of outboard motors and more particularly to a device that locks an outboard motor, with its battery, to a boat hull.

### BACKGROUND

Environmental regulations have driven changes in marine outboard motor design. To lower emissions, new outboard motors are frequently four-stroke rather than two-stroke. While this results in lower harmful the missions, a four-stroke motor is more difficult to start. As a result, the manual pull start that is common on two-stroke motors is often replaced by an electric starting system.

Electric start systems require external batteries. This creates new challenges for vessel operators, particularly those with boats under twenty feet in length. Proper battery installation demands careful attention to safety standards, including secure mounting on permanent plates, environmental protection through weather-resistant enclosures, and installation of appropriate circuit breakers for user and vessel safety.

The portable nature of outboard motors compounds these challenges. While portability allows for easy attachment and removal from vessels, this same characteristic makes these motors vulnerable to theft.

What is needed is a mounting system that integrates a locking device for the outboard motor along with secure and weatherproof battery storage.

### SUMMARY

The outboard motor locking device with battery storage is an integrated solution that combines outboard motor security with battery installation and management for electric start portable outboard motors. The device serves dual purposes: preventing theft of portable outboard motors while providing a safe and secure mounting system for starting batteries.

The outboard motor locking device with battery storage employs a hinged locking mechanism that secures to the existing transom clamp screws of portable outboard motors. This approach eliminates the need for additional mounting hardware while creating a theft-resistant connection between the motor and vessel. The locking mechanism consists of two C-channel aluminum extrusions with oval cutouts. The channels close around the motor's clamp screws, the oval cutouts providing room for the outboard motor mounting bracket. The locking mechanism is secured with a standard padlock.

PVA self-adhesive foam gaskets optionally line the interior surfaces of the C-channel members, preventing metal-to-metal contact that could cause rattling during operation and protecting the painted surfaces of the transom clamp screws from scratching.

Attached to the locking mechanism is a weather-resistant aluminum box containing a marine battery suitable for engine starting and accessory power. The battery is secured within the box using a strap optionally lined with PVA foam gasket material. This gasket system serves multiple critical functions: it prevents battery movement that would loosen electrical connections, it protects wiring from work hardening due to vibration, which can cause the wire to be brittle, and cushions the battery from shock loads during vessel operation.

The battery box features pre-installed wiring with appropriate gauge conductors, eliminating the need for users to understand or implement marine electrical standards. A large-capacity circuit breaker provides overcurrent protection and allows users to safely disconnect power when removing or servicing the unit.

The battery box incorporates several safety features. External connectors allow direct connection to the outboard motor's electrical system without exposing the terminals of the battery. The circuit breaker switch is operable from the outside of the box, providing convenient access for power disconnection. A weather-resistant vent maintains proper pressure equalization while protecting internal components from water intrusion.

The integrated design provides multiple layers of theft protection. When the locking mechanism secures the motor to the transom, it simultaneously secures the battery box as a single unit. The battery cannot be removed without first unlocking and removing the entire assembly from the motor because the fasteners that must be removed to access the battery face the transom when the device is locked in place. This creates a theft deterrent as thieves must defeat the padlock and remove both the motor security device and battery together, rather than targeting just the battery. Specifically, the battery enclosure hangs from the lower half, or second half, of the locking device. Removal of the locking device is required to access the battery held within the battery enclosure.

Additionally, the tamper-resistant construction of the battery box prevents access to the battery terminals or internal connections, eliminating quick disconnection and removal. Unlike traditional battery installations where batteries sit unsecured or held with simple straps, the outboard motor locking device with battery storage makes battery theft as difficult as stealing the motor itself.

Installation is performed with general purpose tools. Users position the device on their outboard's clamp screws, close the locking mechanism, and connect the pre-wired leads to their motor. This approach transforms a complex installation requiring hours of skilled labor into a simple attachment process taking minutes.

By integrating theft prevention with battery installation, the outboard motor locking device with battery storage addresses multiple vessel operation challenges in a single device. Boat owners gain peace of mind through enhanced security while ensuring their electrical systems meet established safety standards. The elevated mounting position keeps the battery above potential water levels in swamped vessel conditions, providing an additional safety benefit over traditional floor-mounted battery installations.

### BRIEF DESCRIPTION OF THE DRAWINGS

The invention can be best understood by those having ordinary skill in the art by reference to the following detailed description when considered in conjunction with the accompanying drawings in which:

FIG. 1 is a perspective view of the outboard motor locking system with battery enclosure showing the lock bar in an open position ready to receive transom clamp screws.

FIG. 2 is a side view of the complete assembly with the lock bar in a closed and locked position, showing the internals of the battery housing and electrical connections.

FIG. 3 is a view of the lock bar components showing the upper bar, lower bar, and pivot mechanism.

FIG. 4 is a second view of the lock bar components showing the upper bar, lower bar, and pivot mechanism.

FIG. 5 is a front view of the complete assembly in the locked position showing the breaker switch and terminal access.

FIG. 6 is a rear view of the assembly showing the electrical terminal connections for interfacing with the outboard motor.

FIG. 7 is a top view of the lock bar and housing.

FIG. 8 is a side view of the assembly.

FIG. 9 is an in-use view showing the complete installation with the assembly securing an outboard motor to a boat transom.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

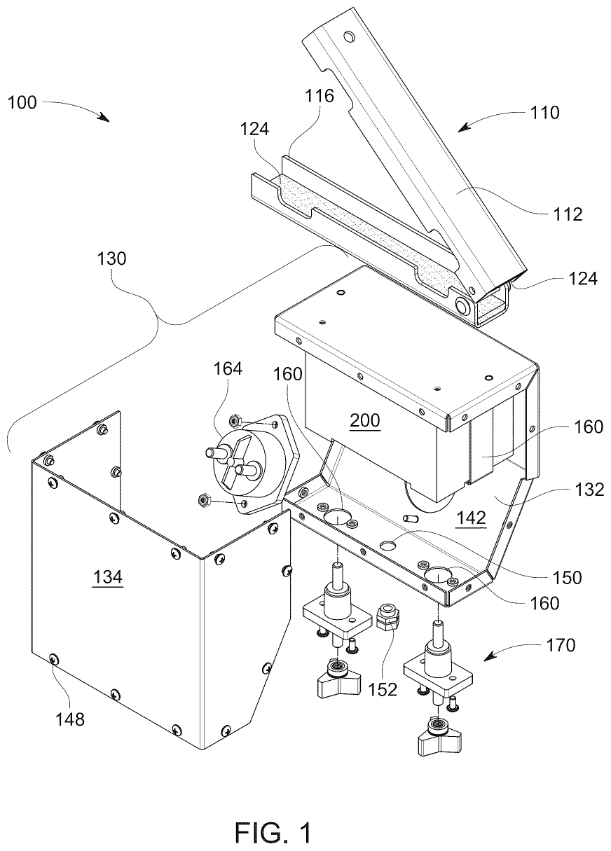

FIG. 1 shows a perspective view of the complete outboard motor locking system with battery enclosure 100. The lock bar 110 is shown in an open position, ready to surround the transom clamping screws. The battery housing 130 is attached to the lock bar 110.

The lock bar gasket 124 is shown on the upper bar 112 and the lower bar 116. The lock bar gasket 124 prevents metal-to-metal contact that could cause rattling during operation and protecting the painted surfaces of the transom clamp screws from scratching.

The battery housing 130 is formed from a housing first half 132 and a housing second half 134, joined by fasteners 148. The battery 200 is visible within the battery housing 130. The breaker switch 164 is mounted on the housing front 142, with terminals 170 accessible for electrical connections.

The vent hole 150 is shown with venting device 152. The venting device 152 manages the air pressure within the battery housing 130, while excluding water.

Terminal holes 160 receive the terminals 170.

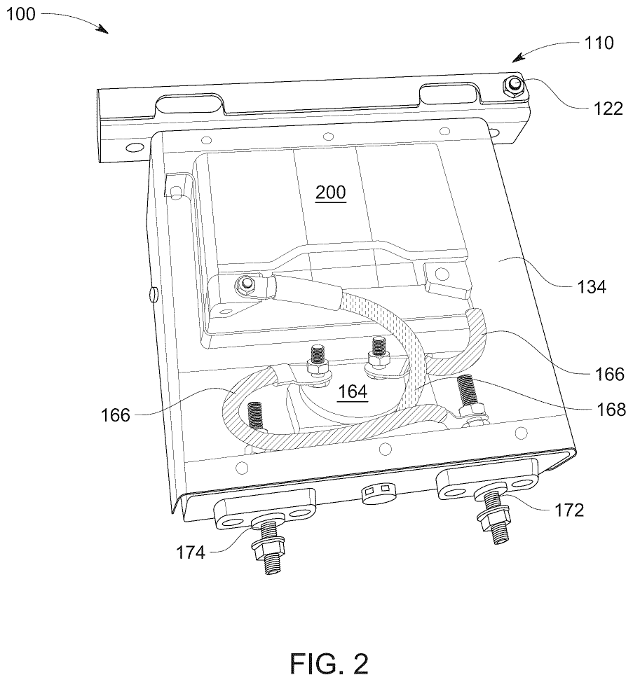

FIG. 2 illustrates a side view of the outboard motor locking system with battery enclosure 100 with the lock bar 110 in the closed position. In this figure, the housing second half 134 is shown as transparent to see the internal components. In the preferred embodiments the housing second half 134 is formed from opaque sheet metal, although in alternative embodiments plastic is substituted.

Positive wiring 166 and negative wiring 168 are visible connecting internal components. The breaker switch 164 is connected in-line with the positive wiring 166, allowing for connection and disconnection of power between the battery 200 and the outboard motor.

The positive terminal 172 and negative terminal 174 extend from the housing. The battery 200 is contained within the battery housing 130. The pivot pin 122 is shown at the hinge point of the lock bar 110.

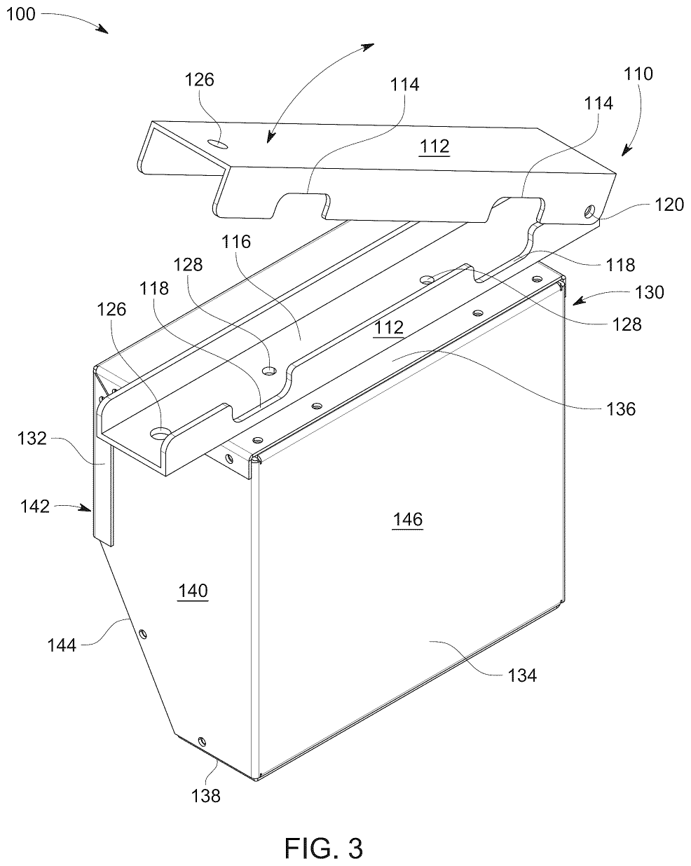

FIG. 3 provides an exploded view of the lock bar 110 assembly. The upper bar 112 with upper cutouts 114 is shown separated from the lower bar 116 with lower cutouts 118. The pivot 120 connects the two bars. Lock bar gasket 124 (see FIG. 1) is optionally positioned to line the interior surfaces. Padlock holes 126 are visible on the upper bar 112 and the lower bar 116 bars for securing in a closed position. Battery box mounting holes 128 are shown for attaching the battery housing 130. The housing first half 132, housing second half 134, housing top 136, housing bottom 138, housing sides 140, housing front 142, housing angled front panel 144, and housing back 146 components of the battery housing 130 are visible.

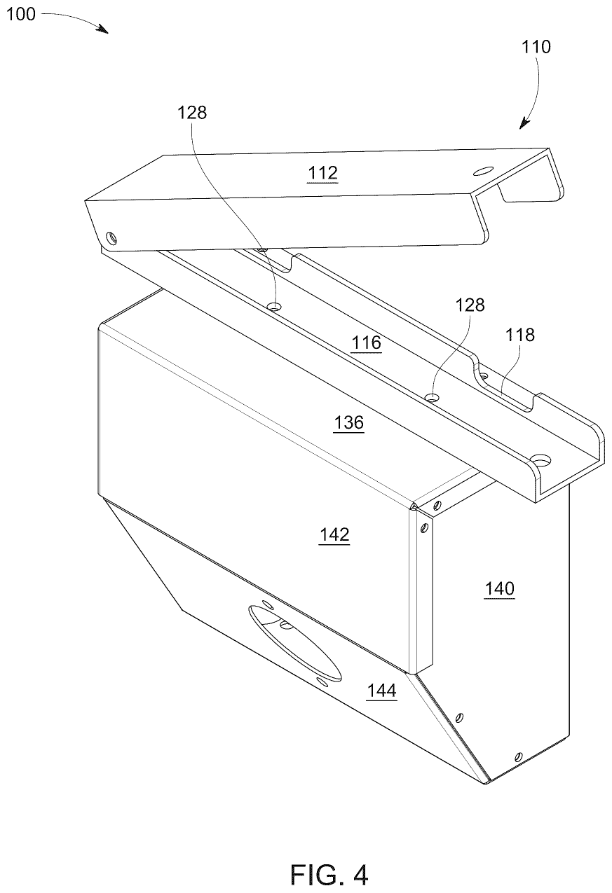

FIG. 4 depicts assembly details. The outboard motor locking system with battery enclosure 100 shows the lock bar 110 with upper bar 112 and lower bar 116 containing lower cutouts 118. The battery box mounting holes 128 connect to the battery housing 130. Housing top 136, housing bottom 138, housing sides 140, housing front 142, and housing angled front panel 144 are indicated.

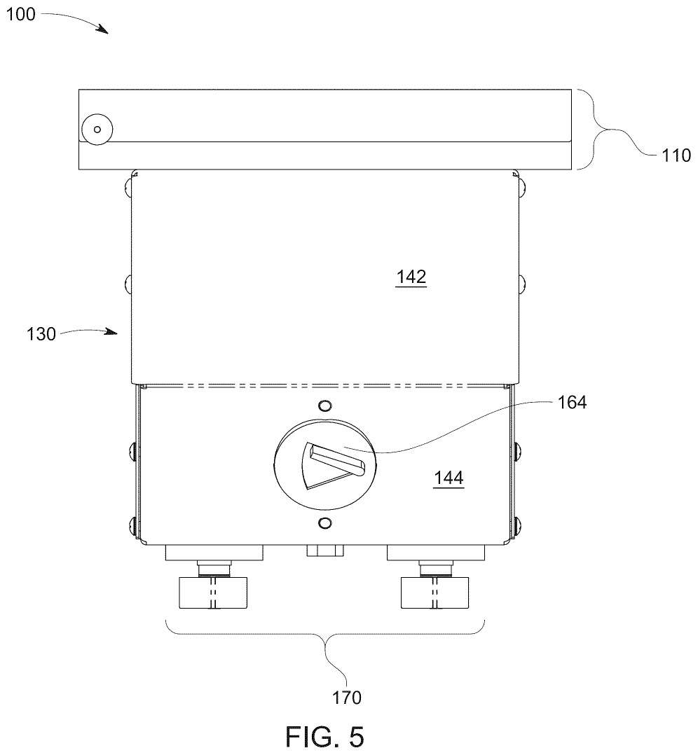

FIG. 5 shows a front view of the outboard motor locking system with battery enclosure 100. The lock bar 110 is in the closed position. The battery housing 130 is attached, with terminals 170 visible. The housing front 142 and housing angled front panel 144 are shown with the breaker switch 164 mounted for access.

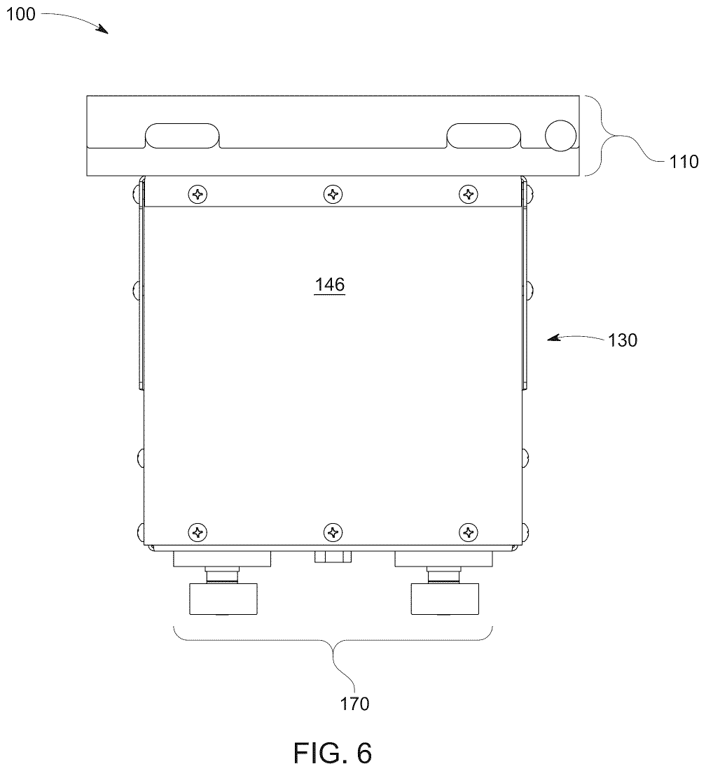

FIG. 6 presents a rear view of the outboard motor locking system with battery enclosure 100. The lock bar 110 supports the battery housing 130. The housing back 146 is prominent in this view. Terminals 170 are accessible for electrical connections.

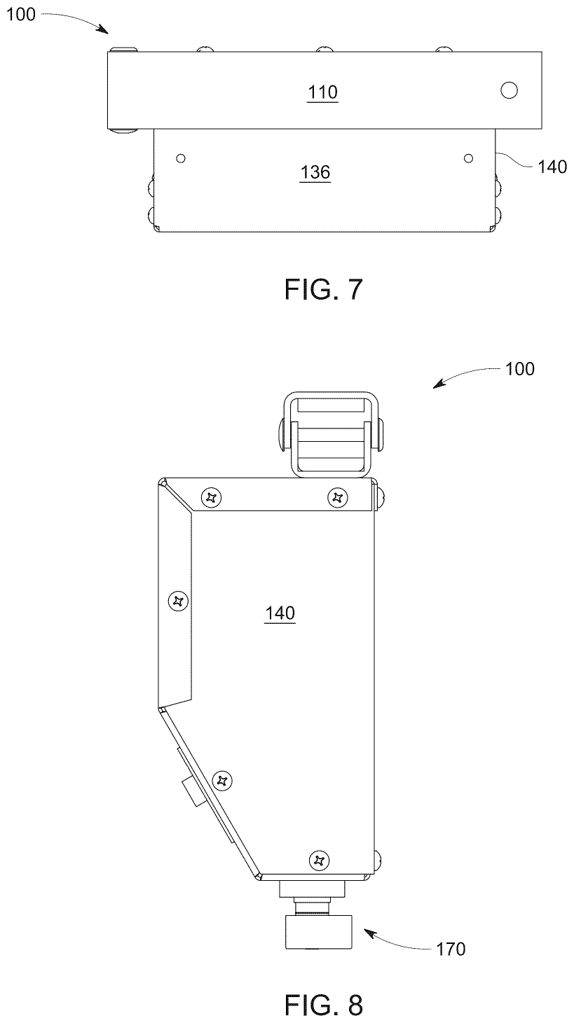

FIG. 7 illustrates a top view of the outboard motor locking system with battery enclosure 100. The lock bar 110 is shown in closed position. The housing top 136 and housing sides 140 of the battery housing 130 are visible from this angle.

FIG. 8 demonstrates the outboard motor locking system with battery enclosure 100 with the lock bar 110 closed. The battery housing 130 with terminals 170 is shown in the operational position. A housing side 140 is visible.

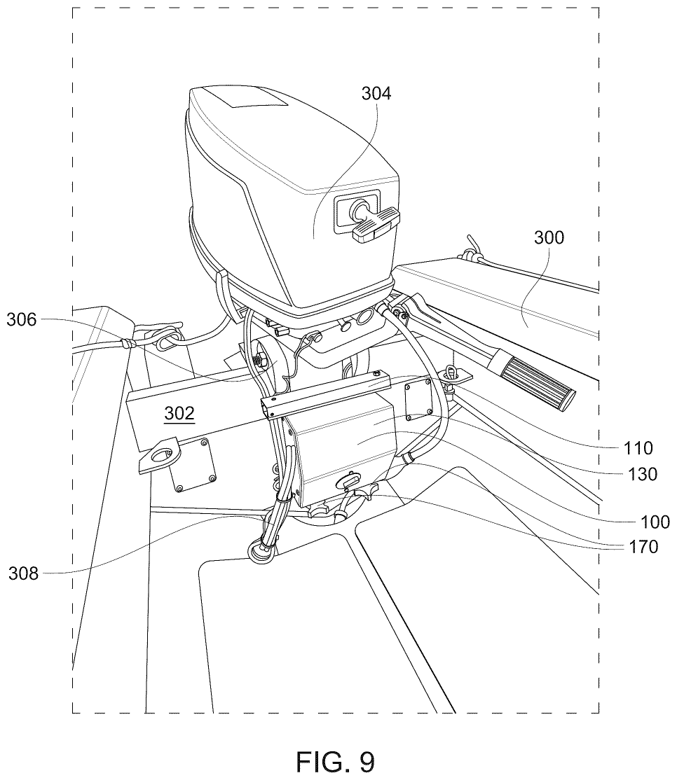

FIG. 9 details the complete installation showing the outboard motor locking system with battery enclosure 100 interfacing with a boat 300. The transom 302 provides the mounting surface. An outboard motor 304 with motor mounting bracket 306 is secured by the lock bar 110. The battery housing 130 with terminals 170 hangs at the proper position. Power wiring 308 connects the outboard motor 304 to the terminals 170 of the outboard motor locking system with battery enclosure 100.

Equivalent elements can be substituted for the ones set forth above such that they perform in substantially the same manner in substantially the same way for achieving substantially the same result.

What is claimed is:

1. An outboard motor locking device for securing an outboard motor and a battery to a transom of a boat the outboard motor locking device comprising:
a lock mechanism;
the lock mechanism to secure to a set of transom clamp screws of the outboard motor;
a battery enclosure;
the battery enclosure suspended from the lock mechanism;
the battery enclosure including an access cover;
the access cover facing the transom of the boat when the outboard motor locking device is in an installed position;
wherein the access cover is obstructed by a transom when the lock mechanism is secured to the set of transom clamp screws in an installed position, preventing access to the battery.

2. The outboard motor locking device of claim 1, the lock mechanism comprising:
a lock bar with an upper bar and upper cutouts, and a lower bar with lower cutouts;
whereby clamping action of the upper bar against the lower bar surrounding the set of transom clamp screws of the outboard motor to prevent actuation of the set of transom clamp screws.

3. The outboard motor locking device of claim 1, wherein:
the battery enclosure is formed from a housing first half and a housing second half, the housing second half acting as the access cover;
the housing first half is affixed to a lower bar of the lock mechanism;
the housing second half is affixed to the housing first half via fasteners;
the fasteners affixing the housing second half to the housing first half placed against the transom of the boat when the outboard motor locking device is in its installed position, with the lock mechanism surrounding the set of transom clamp screws.

4. The outboard motor locking device of claim 2, wherein:
the battery enclosure is formed from a housing first half and a housing second half, the housing second half acting as the access cover;
the housing first half is affixed to the lock mechanism;
the housing second half is affixed to the housing first half via fasteners;
the fasteners affixing the housing second half to the housing first half placed against the transom of the boat when the outboard motor locking device is in its installed position, with the lock mechanism surrounding the set of transom clamp screws.

5. The outboard motor locking device of claim 1, the battery enclosure further comprising a breaker switch;
the breaker switch accessible from an exterior of the battery enclosure.

6. The outboard motor locking device of claim 4, the battery enclosure further comprising:
positive wiring and negative wiring;
the positive wiring connected across a breaker switch.

7. A theft prevention system for an outboard motor and a battery of a boat, the theft prevention system comprising:
a lock mechanism configured to secure an outboard motor to a transom by enclosing a set of transom clamp screws;
a battery enclosure attached to the lock mechanism; and
wherein the battery enclosure is positioned such that at least a portion of the battery enclosure is blocked by the transom when the lock mechanism is in an installed position.

8. The theft prevention system of claim 7, the lock mechanism comprising:
a lock bar with an upper bar and upper cutouts, and a lower bar with lower cutouts;
whereby clamping action of the upper bar against the lower bar surrounding the set of transom clamp screws of the outboard motor to prevent actuation of the set of transom clamp screws.

9. The theft prevention system of claim 7, wherein:
the battery enclosure is formed from a housing first half and a housing second half;
the housing first half is affixed to a lower bar of the lock mechanism;
the housing second half is affixed to the housing first half via fasteners;
the fasteners affixing the housing second half to the housing first half placed against the transom of the boat when the theft prevention system is in its installed position, with the lock mechanism surrounding the set of transom clamp screws.

10. The theft prevention system of claim 8, wherein:
the battery enclosure is formed from a housing first half and a housing second half;
the housing first half is affixed to the lock mechanism;
the housing second half is affixed to the housing first half via fasteners;
the fasteners affixing the housing second half to the housing first half placed against the transom of the boat when the theft prevention system is in its installed position, with the lock mechanism surrounding the set of transom clamp screws.

11. The theft prevention system of claim 7, the battery enclosure further comprising a breaker switch;
the breaker switch accessible from an exterior of the battery enclosure.

12. The theft prevention system of claim 11, the battery enclosure further comprising:
positive wiring and negative wiring;
the positive wiring connected across a breaker switch.

13. An outboard motor security device comprising:
a hinged lock bar having a first member and a second member;
the first member and the second member each including cutouts configured to surround transom clamp screws of an outboard motor;
a battery enclosure suspended from the second member of the hinged lock bar;
the battery enclosure comprising:
a housing configured to contain a marine battery;
electrical terminals extending from the housing for connection to the outboard motor;
a circuit breaker accessible from an exterior of the housing; and
wherein the battery enclosure is oriented such that fasteners securing the battery enclosure are inaccessible when the hinged lock bar is closed around the transom clamp screws.

14. The outboard motor security device of claim 13, further comprising:
a gasket material lining interior surfaces of the cutouts;
wherein the gasket material prevents direct contact between the hinged lock bar and the transom clamp screws.

15. The outboard motor security device of claim 14, wherein:
the gasket material comprises PVA foam.

16. The outboard motor security device of claim 13, wherein:
the battery enclosure further comprises a vent; and
the vent includes a venting device that maintains pressure equalization while preventing water intrusion.

17. The outboard motor security device of claim 13, wherein:
the cutouts are oval-shaped to accommodate a motor mounting bracket of the outboard motor when the hinged lock bar is closed.
